(19) United States
(12) Patent Application Publication
(10) Pub. No.: US 2015/0328083 A1
(43) Pub. Date: Nov. 19, 2015

(54) LIGHTWEIGHT ELECTRO-MECHANICAL CHEST COMPRESSION DEVICE

(71) Applicant: KONINKLIJKE PHILIPS N.V., Eindhoven (NL)

(72) Inventors: Norman Maurice DELISLE, Manchester, MA (US); Christopher WALDEN, Framingham, MA (US); Scott Alan Alan WUTHRICH, Reading, MA (US); Daniel William JORDAN, III, North Reading, MA (US); Virginia HIGLEY, Tyngsboro, MA (US)

(21) Appl. No.: 14/758,059

(22) PCT Filed: Dec. 26, 2013
(86) PCT No.: PCT/IB2013/061333

§ 371 Date: Jun. 26, 2015

Related U.S. Application Data
(60) Provisional application No. 61/746,652, filed on Dec. 28, 2012.

(51) Int. Cl. A61H 31/00

(52) U.S. Cl. CPC A61H 31/006; A61H 31/008; A61H 31/005; A61H 2201/1215; A61H 2205/084; A61H 2201/149; A61H 2201/1621; A61H 2201/1664; A61H 2203/0456

(57) ABSTRACT

An electro-mechanical CPR device (10, 11) for applying cardiopulmonary compressions to a chest of a patient employs a chest compressor (20), one or more straps (40) and a compression controller (30). Chest compressor (20) is self-supportable upon the chest of the patient and includes assembly an electric motor (50), a mechanical transmission (60), a linear actuator (70) and a plunger (80) mounted within a housing (100) wherein the linear actuator (70) converts rotational motion generated by the electric motor (50) and the mechanical transmission (60) into linear motion of the plunger (80) for applying a compressive force (21) to the chest of the patient. Strap(s) (40) wrap around the patient and is(are) coupled to chest compressor (20). Compression controller (30) is external to the chest compressor (20) and applies power and controls signals to the electric motor (50).

The present invention generally relates to electro-mechanical cardiopulmonary compression (“CPR”) devices. The present invention specifically relates to electro-mechanical CPR devices including a chest compressor light enough to be placed self-supported on a patient's chest and a compression controller for operating the chest compressor to produce high quality chest compressions for the patient.

A chest compression cycle consists of a compression phase and a release phase. Specifically, the compression phase involves a compression of the chest in the area of the sternum to squeeze the heart chambers whereby oxygenated blood flows to vital organs, and the release phase involves an expansion of the chest whereby the heart chambers refill with blood. For a high quality chest compression, it is important that a sufficient amount of blood returns to the heart chamber during the release phase. However, if a heavy chest compressor sits on the patient's chest, then the chest expansion is limited whereby perfusion is not as good because the amount of blood returning to the heart chambers is reduced.

Electro-mechanical CPR devices typically weight 20 pounds or more. Due to this weight, if the CPR device sits directly on the patient's chest, then the CPR device will provide a pre-load that will interfere with the efficacy of the CPR compressions. To avoid pre-loading of the chest, piston-type electro-mechanical CPR devices typically will elevate the compression unit above the patient's chest using assemblies with rigid legs that attach to a rigid backboard. In order to accommodate the range of possible patient sizes, this rigid support mechanism must provide a height adjustment to position the plunger on the patient's chest. As the compression force pushes against the patient's chest, the equal and opposite reaction force pulls against the legs and backboard structure. The need for the legs and backboard and height adjust mechanism, increase the weight and size of the overall system, and increase the time needed to set up the system and start compressions.

The present invention separates the controller from the chest compressor whereby the the weight of the chest compressor is significantly reduced to be light enough to sit directly on the patient's chest without a rigid support structure. Therefore, the chest compressor may be secured to the patient using a simple wrap-around strap. During operation, the downward force of the chest compressor's plunger is counteracted by the strap to effectively compress the patient's chest.

One form of the present invention is a CPR device employing a chest compressor, a compression controller connected to the chest compressor via a power/control cable and one or more straps wrapped around the patient and coupled to the chest compressor. The chest compressor includes an assembly of an electric motor, a mechanical transmission, a linear actuator and a plunger mounted within a housing, and may further include a position sensor and/or a force sensor. In operation, the chest compressor is self-supported upon a patient's chest and the compression controller provides power and control signals to the electric motor to activate the plunger in a linear motion for applying a controlled compressive force to the patient's chest.

The foregoing form and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

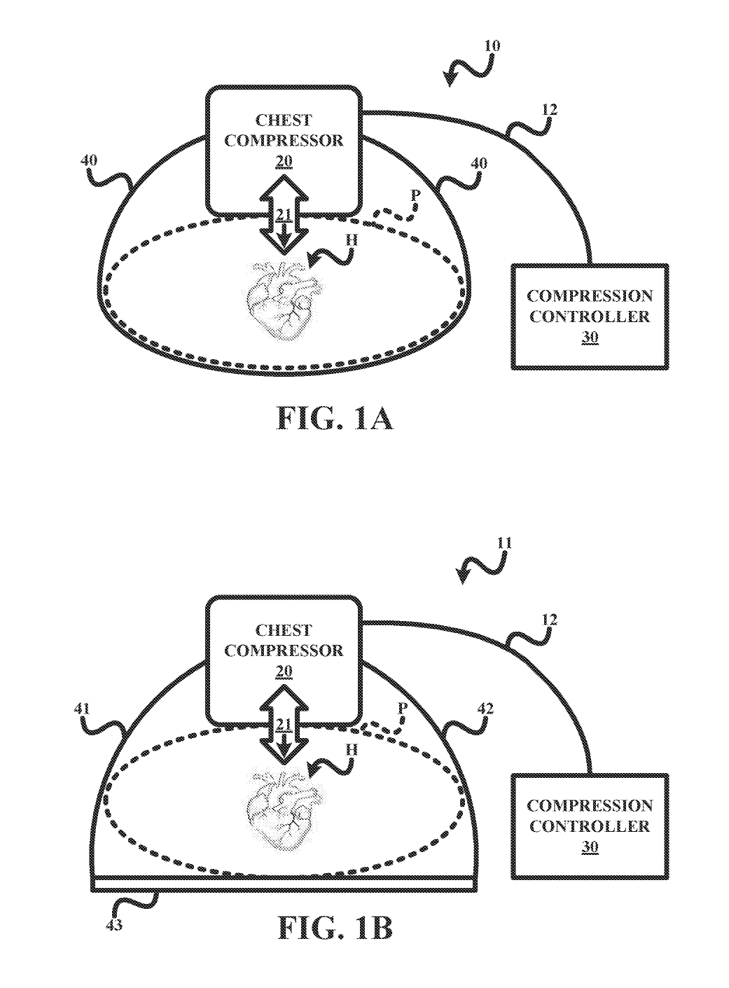

FIG. 1A illustrates a first exemplary embodiment of a CPR device in accordance with the present invention.

FIG. 1B illustrates a second exemplary embodiment of a CPR device in accordance with the present invention.

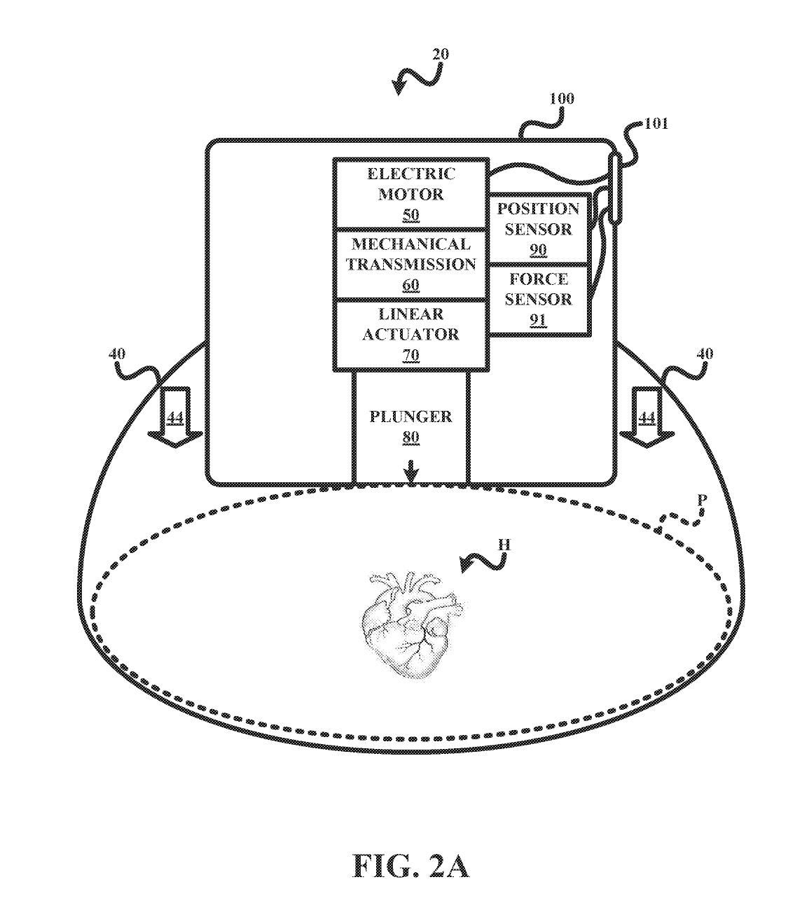

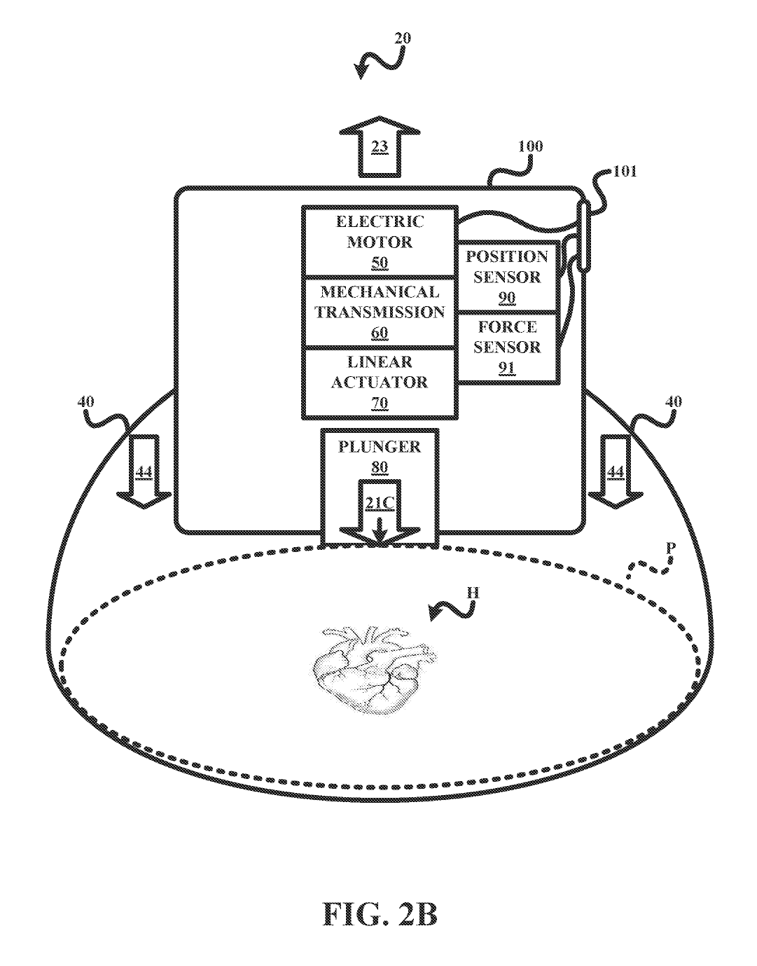

FIGS. 2A and 2B illustrate an exemplary embodiment of a chest compressor in accordance with the present invention.

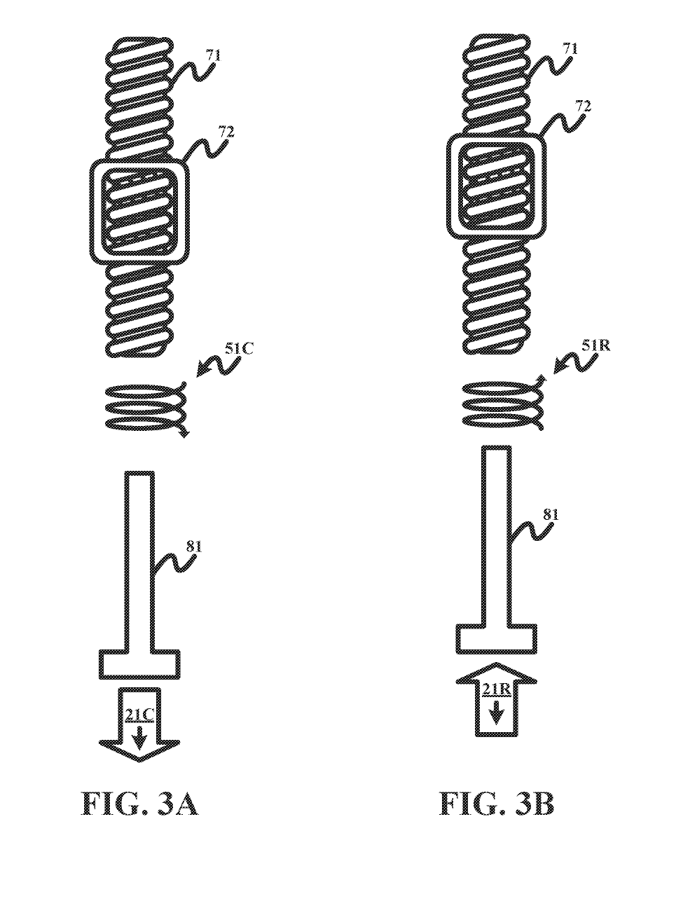

FIGS. 3A and 3B illustrate a first exemplary embodiment of a linear actuator in accordance with the present invention.

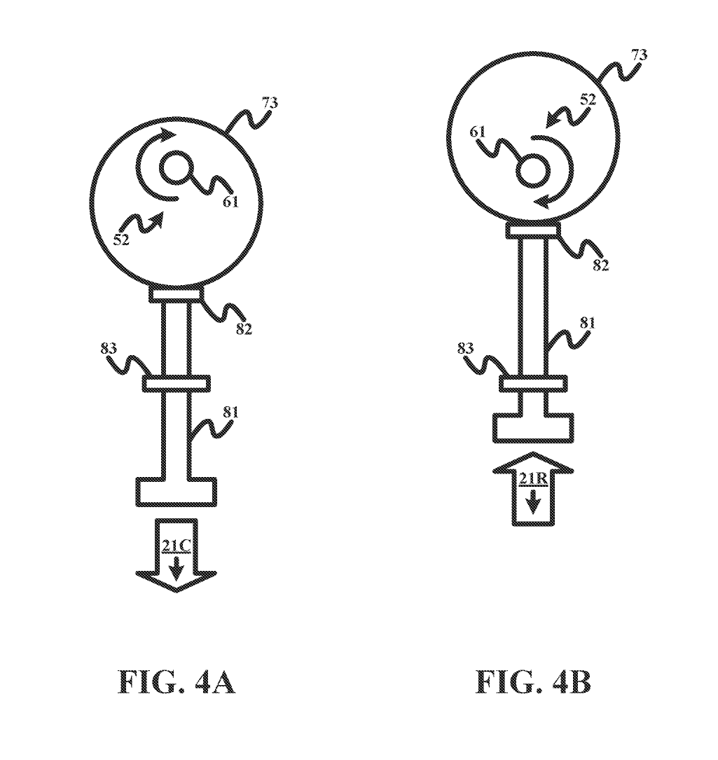

FIGS. 4A and 4B illustrate a second exemplary embodiment of a linear actuator in accordance with the present invention.

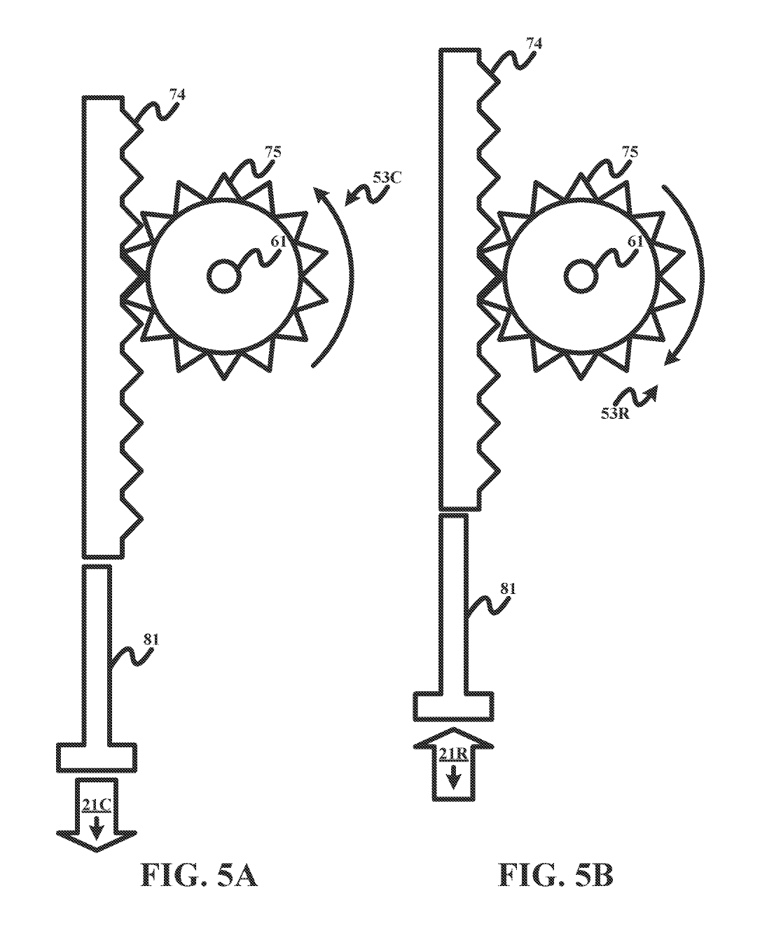

FIGS. 5A and 5B illustrate a third exemplary embodiment of a linear actuator in accordance with the present invention.

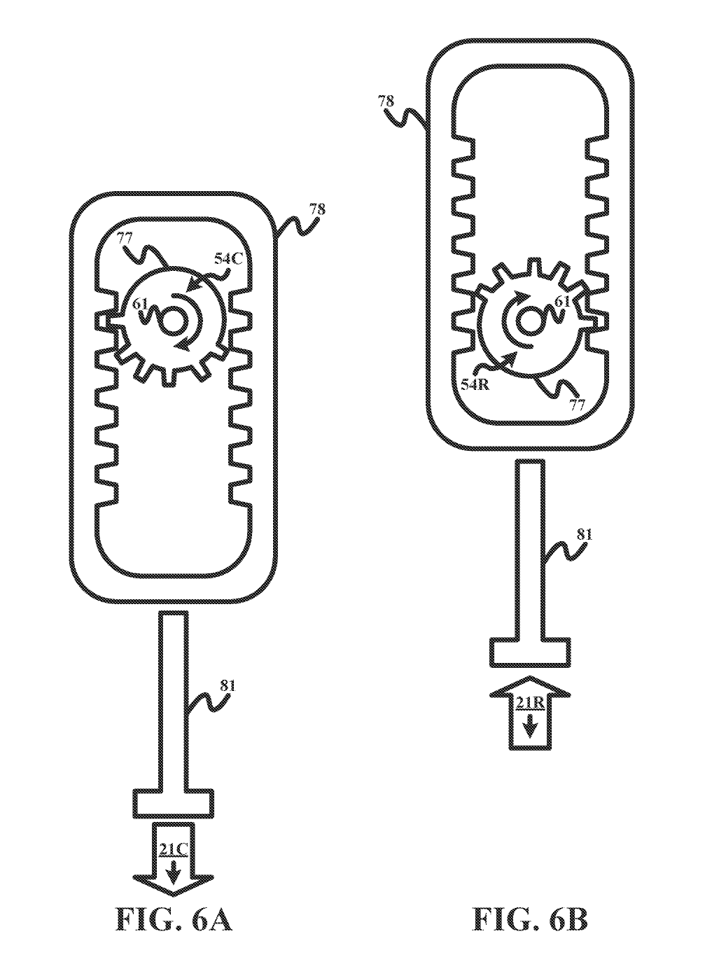

FIGS. 6A and 6B illustrate a fourth exemplary embodiment of a linear actuator in accordance with the present invention.

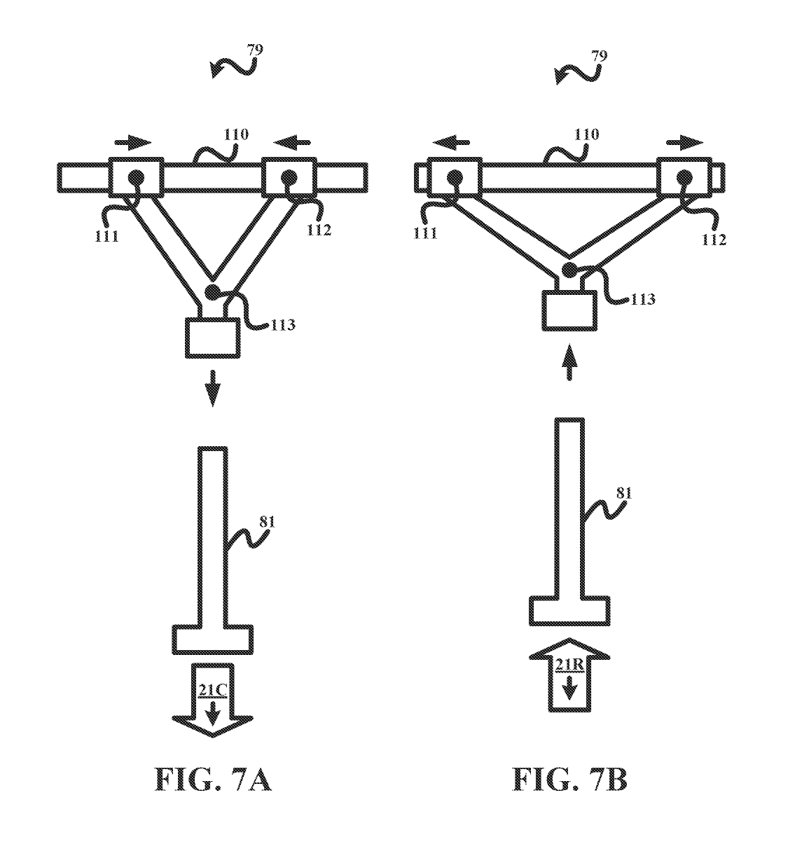

FIGS. 7A and 7B illustrate a fifth exemplary embodiment of a linear actuator in accordance with the present invention.

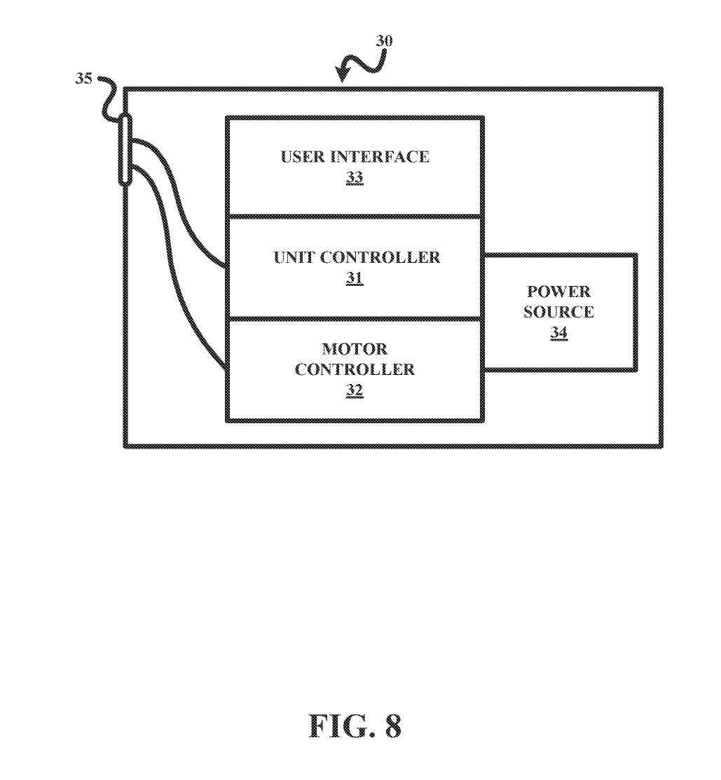

FIG. 8 illustrates an exemplary embodiment of a compression controller in accordance with the present invention.

Referring to FIG. 1A, an electro-mechanical CPR device 10 of the present invention provides a high quality compression of a chest of a patient P shown in a cross-sectional view. To this end, CPR device 10 employs a chest compressor 20, a compression controller 30 and a strap 40. In operation, chest compressor 20 is self-supported upon a sternum area of the chest of a patient P with strap 40 being wrapped around patient P and coupled to sides of chest compressor 20. Compression controller 30 provides power and control signals to chest compressor 20 via a power/control cable 12 to apply a cyclical compressive force 21 to the chest of patient P. The lightweight of chest compressor 20 facilitates a high quality chest compression of patient P involving compression of the chest in the area of the sternum to squeeze chambers of a heart H of patient P chambers whereby oxygenated blood flows to vital organs and an unlimited expansion of the chest of patient P whereby blood refills chambers of heart H without any inhibition by the weight of chest compressor 20. More particularly, the lightweight of chest compressor 20 has an insignificant pre-load represented by the arrow within compressive force 21 that will not interfere with the efficacy of the CPR compressions.

FIG. 1B illustrates an electro-mechanical CPR device 11 of the present invention employing, alternative to strap 40, a backboard 43 coupled to chest compressor 20 via a pair of straps 41 and 42. With the employment of chest compressor 20 and compression controller 30, CPR device 11 provides the same high quality compression of the chest of patient P as CPR device 10.

FIGS. 2-7 will now be described herein to facilitate an understanding of the self-supporting and lightweight features of chest compressor 20.

Referring to FIG. 2A, chest compressor 20 includes an assembly of an electric motor 50, a mechanical transmission 60, a linear actuator 70 and a plunger 80 mounted within a housing 100.

For purposes of chest compression, electric motor 50 is broadly defined herein as any electric motor structurally configured to generate a rotational motion and mechanical transmission 60 is broadly defined herein as any transmission structurally configured for reducing and transmitting the rotational motion from electric motor 50 to linear actuator 70. Examples of electric motor 50 suitable for chest compressor 20 include, but are not limited to, are brushless DC electric motors. Examples of mechanical transmission 60 suitable for chest compressor 20 include, but are not limited to, gear mechanisms/boxes and pulley/belt systems.

Also for purposes of chest compression, linear actuator 70 is broadly defined herein as any actuator structurally configured to convert the rotational motion into linear motion, and plunger 80 is broadly defined herein as any article structurally configured responsive to the reciprocating linear motion for applying an cyclical compressive force in specified distributive manner to the chest of patient P (e.g., a substantially equal distribution of the force along a compressive surface of plunger 80 in physical contact with patient P).

Chest compressor 20 may further include a position sensor 90 for determining a position of plunger 80 relative to a baseline position and a force sensor 91 for determining a magnitude of the compressive force applied to the chest of patient P.

In practice, components 50-80 and optionally components 90 and 91 may be assembled and mounted within housing 100 in any configuration that applies an insignificant pre-load to the chest of the patient. In one embodiment as shown in FIG. 2A, a deactivated state of CPR device 20 involves plunger 80 being retracted to a baseline position whereby a compressive surface (not shown) of plunger 80 is flush with or extended through an opening (not shown) in the bottom surface of housing 100. For this embodiment, the compressive surface of plunger 80 supports chest compressor 20 on the sternum area of the chest of patient P while applying an insignificant pre-load upon the sternum area of the chest of patient P. In an alternative embodiment, the deactivated state of CPR device 20 involves plunger 80 being retracted to a baseline position whereby the compressive surface of plunger 80 retracted is within housing 100. For this embodiment, the bottom surface of housing 100 supports chest compressor 20 on the sternum area of the chest of patient P while applying an insignificant pre-load upon the sternum area of the chest of patient P.

Furthermore, strap 40 is coupled to side surfaces of housing 100 by any means suitable for applying a counter-compressive force 44 to housing 100 that does not add significantly to the pre-load of chest compressor 20 upon the sternum area of the chest of patient P. More particularly, strap 40 is adjustable to accommodate various patient sizes and the process of attaching strap 40 to chest compressor 20 may involve some tightening. Thus, in practice, the design of chest compressor 20 and strap 40 should ensure that there is enough travel of the plunger 81 to take up any slack in the strap 40 so the tightness is not a critical adjustment and an operator of CPR device 40 will not be inclined to over tighten strap 40.

In operation, as shown in FIG. 2B, a compression phase of an activated state of chest compressor 20 involves an activation of electric motor 50 via compression controller 30 (FIG. 1) whereby plunger 80 from the baseline position to one of a various compression positions ranging from a minimal compression position (e.g., zero (0) inches) to a maximum compression position (e.g., two (2) inches for adults) in dependence upon the compression algorithm being implemented by compression controller 30. The extension of plunger 80 from the baseline position to a compression position exerts an upward reactive force 23 upon housing 100 that is nullified by counter-compressive force 44 of straps 40.

The release phase of the activated state of chest compressor 20 involves a retraction of plunger to the baseline position as shown in FIG. 2A or a lesser compression position in dependence upon the compression algorithm being implemented by compression controller 30. The activated state of chest compressor will cycle through the compression phase (FIG. 2B) and the release phase (FIG. 2A) also in dependence upon the compression algorithm being implemented by compression controller 30.

FIGS. 3-7 will now be described herein to facilitate an understanding of various embodiments of linear actuator 70 in converting the rotational motion from electric motor 50 and mechanical transmission 60 into reciprocating linear motion for plunger 80.

FIGS. 3A and 3B illustrate a first embodiment of linear actuator 70 in the form of a motor driven ball screw. In one version, during the compression phase, a screw shaft 71 is rotated with a compressive rotational motion 51C by a compressive forward motion of electric motor 50 and mechanical transmission 60 whereby a nut 72 is linearly displaced in a downward direction to linearly extend plunger 81 in a downward compressive motion 21C as shown in FIG. 3A. During the release phase, screw shaft 71 is rotated with a retraction rotational motion 51R of electric motor 50 and mechanical transmission 60 whereby nut 72 is linearly displaced in an upward direction to linearly retract plunger 81 in an upward retractive motion 21R as shown in FIG. 3B. In practice, plunger 81 is attached to nut 72 and nut 72 slides in a channel or other sliding pathway to (not shown) prevent the nut 72 from rotating.

In an alternative version, during the compression phase, nut 72 is rotated with compressive rotational motion 51C by electric motor 50 and mechanical transmission 60 whereby screw shaft 71 is linearly displaced in a downward direction to linearly extend plunger 81 in a downward compressive motion 21C as shown in FIG. 3A. During the release phase, nut 72 is rotated with release rotational motion 51R by electric motor 50 and mechanical transmission 60 whereby screw shaft 71 is linearly displaced in an upward direction to linearly retract plunger 81 in an upward retractive motion 21R as shown in FIG. 3B. In practice, plunger 81 is attached to the screw shaft 71 and screw shaft 71 slides in a channel or other sliding pathway to (not shown) prevent the screw shaft 71 from rotating.

FIGS. 4A and 4B illustrate a second embodiment of linear actuator 70 in the form of a reciprocating cam mechanism. Mechanical transmission 60 has a shaft 61 attached to a cam 73 and plunger 81 is mechanically coupled to cam 73 via a coupler 82 and linearly aligned via a holder 83. During the compression phase, shaft 61 is rotated in one-direction (e.g., clockwise) with a rotational motion 52 by electric motor 50 whereby cam 73 is rotationally displaced in a downward direction to linearly extend plunger 81 in a downward compressive motion 21C as shown in FIG. 4A. During the release phase, cam 73 is rotationally displaced in an upward direction to linearly retract plunger 81 in an upward retractive motion 21R as shown in FIG. 4B.

In practice, a shape of cam 73 may be designed with constant radius sections to provide dwell whereby shaft 61 may be paused at a fully compressed position of plunger 81 or a fully retracted position of plunger 81. Furthermore, a shape of cam 73 may be designed with a rate of change of the radius to generate a non-linear force profile.

FIGS. 5A and 5B illustrate a third embodiment of linear actuator 70 in the form of a rack and pinion. Mechanical transmission 60 has a shaft 61 attached to a pinion 75. During the compression phase, pinion 75 is rotated with a compressive rotational motion 53C compressive forward motion of electric motor 50 and mechanical transmission 60 whereby rack 74 is linearly displaced in a downward direction to linearly extend plunger 81 in a downward compressive motion 21C as shown in FIG. 5A. During the release phase, pinion 75 is rotated with a release rotational motion 53R retraction rotational motion of electric motor 50 and mechanical transmission 60 whereby rack 74 is linearly displaced in an upward direction to linearly retract plunger 81 in an upward retractive motion 21R as shown in FIG. 5B.

FIGS. 6A and 6B illustrate a fourth embodiment of linear actuator 70 in the form of a two-sided reciprocating rack and pinion. Mechanical transmission 60 has a shaft 61 attached to a pinion 77. During the compression phase, pinion 77 is rotated with a rotational motion 54C by electric motor 50 and mechanical transmission 60 whereby rack 78 is linearly displaced in a downward direction to linearly extend plunger 81 in downward compressive motion 21C as shown in FIG. 6A. During the release phase, pinion 77 is rotated with a rotational motion 54C by electric motor 50 and mechanical transmission 60 whereby rack 78 is linearly displaced in an upward direction to linearly retract plunger 81 in upward retractive motion 21R as shown in FIG. 6B.

FIGS. 7A and 7B illustrate a fifth embodiment of linear actuator 70 in the form of a V-drive 79. Mechanical transmission 60 has a pulley/rope system (not shown) attached to a pivot point 111 and a pivot point 112 of a V-drive 79 operated by a rotational motion generated by electric motor 50. During the compression phase, the motor rotates in a compressive motion pulling the pulley/rope system slides pivot points 111 and 112 closer together along a slide bar 110 whereby a pivot point 113 of V-drive 79 is linearly displaced in a downward direction to linearly extend plunger 81 in downward compressive motion 21C as shown in FIG. 7A. During the release phase, the motor rotates in a release motion pulling the pulley/rope system slides pivot points 111 and 112 further apart along slide bar 110 whereby pivot point 113 of V-drive 79 is linearly displaced in an upward direction to linearly retract plunger 81 in upward retractive motion 21R as shown in FIG. 6B.

Referring back to FIG. 1, compression controller 30 is broadly defined herein as any controller structurally configured with hardware, software and/or firmware for powering chest compressor 20 and for controlling one or more parameters of cyclical compressive force 21 via controls signals applied to electric motor 50. The parameters include, but are not limited to, a frequency of compressive force 21, a duration of compressive force 21, a magnitude profile of compressive force 21 and a depth of compressive force 21.

In one embodiment, as shown in FIG. 8, compression controller 30 employs a user interface 33, a system controller 32, a motor controller 32 and a power source 34. User interface 33 provides a display and button and/or touchscreen controls. System controller 33 is designed to control the overall operation of the CPR device in accordance with user commands and programmed force profiles for chest compressor 20, and motor controller 32 generates the necessary control signals for electric motor 20 in dependence upon a commanded force profile.

In one control embodiment, the force of the plunger 81 is controlled by a closed-loop servo mechanism with position sensor 90 (FIG. 2) and/or force sensor 91 (FIG. 2) be utilized in a feedback loop. More particularly, clinical evidence indicates that the compressive force needed increases as the depth of the compression increases. Thus, the force profile increases the torque of electric motor 30 as plunger 81 is linearly extended to a compression position requiring a proportional increase in the current applied to electric motor 30.

Referring to FIGS. 1, 2 and 8, in operation, power/control cable 12 is connected to cable connector 101 of chest compressor 20 and cable connector 35 of compression controller 30. This connection facilitates a transmission of power/control signals from motor controller 32 to electric motor 30 and a transmission of a position signal from position sensor 90 and a force signal from force sensor 91 to system controller 31.

In practice, compression controller 30 may further a persistent memory (e.g., a flash drive) for recording CPR events; communication technologies for integrating CPR device 10 with other medical devices and/or electronic patient care record systems; and/or a battery charger.

Referring to FIGS. 1-7, those having ordinary skill in the art will appreciate numerous benefits of the present invention including, but not limited to, a high quality chest compression from a lightweight electro-mechanical CPR device.

While various embodiments of the present invention have been illustrated and described, it will be understood by those skilled in the art that the embodiments of the present invention as described herein are illustrative, and various changes and modifications may be made and equivalents may be substituted for elements thereof without departing from the true scope of the present invention. In addition, many modifications may be made to adapt the teachings of the present invention without departing from its central scope. Therefore, it is intended that the present invention not be limited to the particular embodiments disclosed as the best mode contemplated for carrying out the present invention, but that the present invention includes all embodiments falling within the scope of the appended claims.

1. An electro-mechanical CPR device for applying cardiopulmonary compressions to a chest of a patient, the CPR device comprising:
a chest compressor including as assembly an electric motor, a mechanical transmission, a linear actuator and a plunger mounted within a housing,
wherein a weight of the chest compressor (20) is self-supportable by the chest compressor upon the chest of the patient, and
wherein the linear actuator converts rotational motion generated by the electric motor and the mechanical transmission into linear motion of the plunger for applying a compressive force to the chest of the patient;
at least one strap structurally and operably configured to at least partially wrap around the patient and be coupled to the chest compressor; and
a compression controller external to the chest compressor and structurally and operably configured to apply power and control signals to the electric motor for powering and controlling the compressive force to the chest of the patient.

2. The electro-mechanical CPR device of claim 1, wherein the electric motor is a brushless DC electric motor.

3. The electro-mechanical CPR device of claim 1, wherein the mechanical transmission includes at least one of a gear mechanism or a pulley/rope system.

4. The electro-mechanical CPR device of claim 1, wherein the linear actuator includes a motor driven ball screw.

5. The electro-mechanical CPR device of claim 1, wherein the linear actuator includes a cam mechanism.

6. The electro-mechanical CPR device of claim 1, wherein the linear actuator includes a rack and pin mechanism.

7. The electro-mechanical CPR device of claim 1, wherein the linear actuator includes a reciprocating rack and pin mechanism.

8. The electro-mechanical CPR device of claim 1, wherein the linear actuator includes a V-drive mechanism.

9. The electro-mechanical CPR device of claim 1, wherein the at least one strap includes a strap having two ends structurally and operably configured to be coupled to the chest compressor.

10. The electro-mechanical CPR device of claim 1, further comprising:
a backboard structurally and operably configured to support a back of the patient,
wherein the at least one strap includes a pair of straps structurally and operably configured to be coupled to the chest compressor and the backboard.

11. The electro-mechanical CPR device of claim 1, wherein the chest compressor further includes a position sensor in communication with the compression controller to indicate a current position of the plunger relative to a baseline position of the plunger.

12. The electro-mechanical CPR device of claim 1, wherein the chest compressor further includes a force sensor in communication with the compression controller to indicate a magnitude of the compressive force.

13. The electro-mechanical CPR device of claim 1, wherein the compression controller executes a closed-loop servo control of the cyclic compressive force of the plunger.

14. The electro-mechanical CPR device of claim 13, wherein the closed-loop servo control incorporates feedback indicative of at least one of a current position of the plunger relative to a baseline position of the plunger or a magnitude of the compressive force.

15. The electro-mechanical CPR device of claim 1, wherein the compression controller increases a torque of the electric motor as the plunger is being compressed into the chest of the patient.
